(19) United States
(12) Patent Application Publication
(10) Pub. No.: US 2016/0208142 A1
(43) Pub. Date: Jul. 21, 2016

(54) PRESSURE-SESITIVE ADHESIVE SHEET, METHOD OF USING PRESSURE-SENSITIVE ADHESIVE SHEET, AND PRECISION ELECTRONIC DEVICE

(71) Applicant: NITTO DENKO CORPORATION, Osaka (JP)

(72) Inventors: Kenji FURUTA, Osaka (JP); Yoshio TERADA, Osaka (JP); Kota NAKAO, Osaka (JP)

(73) Assignee: NITTO DENKO CORPORATION, Osaka (JP)

(21) Appl. No.: 14/988,847

(22) Filed: Jan. 6, 2016

(30) Foreign Application Priority Data
Jan. 15, 2015 (JP) 2015-005746

(51) Int. Cl. C09J 7/00; C09J 5/00

(52) U.S. Cl. CPC C09J 7/00; C09J 5/00; C09J 2203/326; C09J 2201/606; C09J 2433/00; C09J 2483/005

(57) ABSTRACT

A pressure-sensitive adhesive sheet according to the present invention includes a pressure-sensitive adhesive layer including an acrylic polymer, and a release liner including a release layer made of a silicone release agent, the release layer being applied on the pressure-sensitive adhesive layer. The acrylic polymer includes at least one alkyl(meth)acrylate whose alkyl group being a linear or branched chain alkyl group with a carbon number of 1 to 18 as a monomer unit, and an amount of siloxane gas generated in a unit area of the pressure-sensitive adhesive layer where the release liner is removed is less than 20.0 ng/cm² after heating at 120° C. for ten minutes.

### CROSS-REFERENCE TO RELATED APPLICATION

This application claims priority from Japanese Patent Applications No. 2015-00576 filed on Jan. 15, 2015. The entire contents of the priority application are incorporated herein by reference.

### TECHNICAL FIELD

The present disclosure relates to a pressure-sensitive adhesive sheet, a method of using a pressure-sensitive adhesive sheet and a precision electronic device.

### BACKGROUND

A pressure-sensitive adhesive sheet that generates a smaller amount of siloxane gas has been known (for example, Patent Documents 1 to 3). Such a pressure-sensitive adhesive sheet is preferably used in a situation where siloxane gas is not desired to be generated, for example in a precision electronic device (such as a hard disc drive) or a coating process.

The above pressure-sensitive adhesive sheet includes a release liner for protecting a pressure-sensitive adhesive layer and a non-silicone based release liner has been used. If a silicone based release liner is used as the release liner instead of the non-silicone based release liner, a large amount of silicone compounds may be transferred from the release liner to the pressure-sensitive adhesive layer. The silicone compounds cause generation of siloxane gas. Therefore, non-silicone based release liner should be used as the release liner in a situation where siloxane gas is not desired to be generated.

Patent Document 1: Japanese Unexamined Patent Application Publication No. 2014-162874

Patent Document 2: Japanese Unexamined Patent Application Publication No. 2014-148646

Patent Document 3: Japanese Unexamined Patent Application Publication No. 2009-74060

### SUMMARY

A pressure-sensitive adhesive sheet includes a pressure-sensitive adhesive layer including an acrylic polymer, and a release liner including a release layer made of a silicone release agent, the release layer being applied on the pressure-sensitive adhesive layer. The acrylic polymer includes at least one alkyl(meth)acrylate whose alkyl group being a linear or branched chain alkyl group with a carbon number of 1 to 18 as a monomer unit, and an amount of siloxane gas generated in a unit area of the pressure-sensitive adhesive layer where the release liner is removed is less than 20.0 ng/cm² after heating at 120° C. for ten minutes.

### BRIEF DESCRIPTION OF DRAWINGS

FIG. 1 is a cross-sectional view of a double-sided pressure-sensitive adhesive sheet including a pressure-sensitive adhesive layer.

FIG. 2 is a cross-sectional view of a double-sided pressure-sensitive adhesive sheet including pressure-sensitive adhesive layers on both surfaces of a base member.

FIG. 3 is a cross-sectional view of a one-side pressure-sensitive adhesive tape including a pressure-sensitive adhesive layer on one surface of a base member.

### DETAILED DESCRIPTION

However, the non-silicone based release liner does not have high versatility compared to the silicone based release liner and therefore, use of the non-silicone based release liner may increase a cost of the pressure-sensitive adhesive sheet.

The non-silicone based release liner has heat resisting properties lower than the silicone based release liner and therefore, the pressure-sensitive adhesive sheet including the pressure-sensitive adhesive layer where the non-silicone based release liner is attached cannot be heated according to a heating condition.

The present invention was made to solve the above described problems and to achieve the following objects. An object of the present invention is to provide a pressure-sensitive adhesive sheet including a pressure-sensitive adhesive layer from which siloxane gas is less likely to be generated even with including a silicone based release liner.

Another object of the present invention is to provide a method of using a pressure-sensitive adhesive sheet in a precision electronic device such as a hard disc drive.

Another different object of the present invention is to provide a precision electronic device such as a hard disc drive including the pressure-sensitive adhesive sheet.

The inventors of the present invention conducted an intensive study and found following matters. In the pressure-sensitive adhesive sheet including the pressure-sensitive adhesive layer containing acrylic polymer, the release layer made of silicone based release agent, and the release liner disposed such that the release layer is layered on the pressure-sensitive adhesive layer, the acrylic polymer includes the polar monomer containing an acidic group as a polar group. Therefore, the pressure-sensitive adhesive layer attracts silicone from the release layer and the silicone is adhered to the pressure-sensitive adhesive layer. This causes generation of siloxane gas.

Hereinafter, an embodiment of the present invention will be described with reference to the drawings.

A pressure-sensitive adhesive sheet according to an embodiment includes a pressure-sensitive adhesive layer containing an acrylic polymer, and a release liner including a release layer and a support base supporting the release layer. The release layer includes a silicone release agent and the release liner is attached on the pressure-sensitive adhesive layer with the release layer being layered on the pressure-sensitive adhesive layer.

The pressure-sensitive adhesive sheet may also be referred to by a different name such as a pressure-sensitive adhesive tape and a pressure-sensitive adhesive film. The term “pressure-sensitive adhesive sheet” is used throughout this specification. A surface of the pressure-sensitive adhesive layer of the pressure-sensitive adhesive sheet may be referred to as an “adhesive surface”.

The pressure-sensitive adhesive sheet may be a double-sided pressure-sensitive adhesive sheet having adhesive surfaces on both surfaces of the sheet or may be a one-side pressure-sensitive adhesive sheet having an adhesive surface on only one surface thereof.

The double-sided pressure-sensitive adhesive sheet may be a pressure-sensitive adhesive sheet without a base including no base (a support member) or may be a pressure-sensitive adhesive sheet with a base.

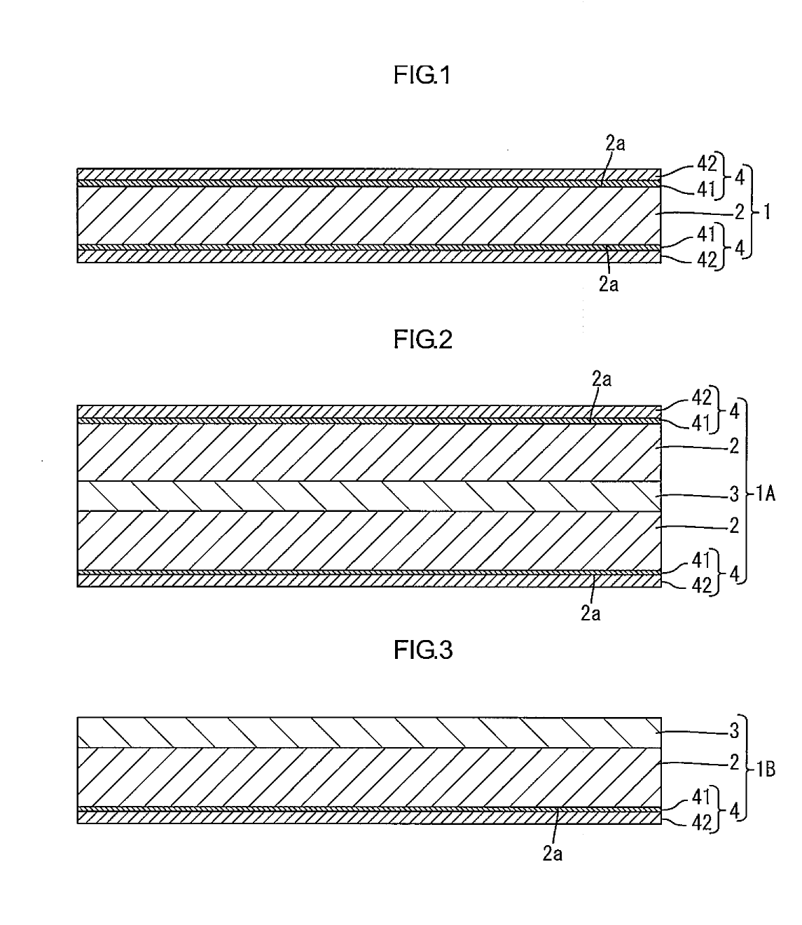

An example of the pressure-sensitive adhesive sheet without a base may be a pressure-sensitive adhesive sheet 1 including release liners 4 that are attached to respective surfaces of a pressure-sensitive adhesive layer 2, as illustrated in FIG. 1. An example of the pressure-sensitive adhesive sheet with a base may be a pressure-sensitive adhesive sheet 1A including pressure-sensitive adhesive layers 2 on respective surfaces of a base 3 and a release liner 4 on one surface of each of the pressure-sensitive adhesive layers 2, as illustrated in FIG. 2.

An example of a one-side pressure-sensitive adhesive sheet may be a pressure-sensitive adhesive sheet 1B including the base 3, the pressure-sensitive adhesive layer 2 on one surface of the base 3 and the release liner 4 attached on one surface of the pressure-sensitive adhesive layer 2, as illustrated in FIG. 3.

The release liner 4 covers an adhesive surface 2a of the pressure-sensitive adhesive layer 2 of the pressure-sensitive adhesive sheet 1, 1A, 1B before using. The release liner 4 is attached to the pressure-sensitive adhesive layer 2 such that the release layer 41 on one surface of the support base 42 is layered on the pressure-sensitive adhesive layer 2. The release liner 4 is removed from the pressure-sensitive adhesive layer 2 when using the pressure-sensitive adhesive sheet 1, 1A, 1B.

The pressure-sensitive adhesive sheet may include other layers, such as an intermediate layer, and an undercoat in addition to the base and the pressure-sensitive adhesive layer as long as the pressure-sensitive adhesive sheet can achieve the object of the present invention.

Hereinafter, the pressure-sensitive adhesive layer and the release liner of the pressure-sensitive adhesive sheet will be described in detail.

[Pressure-Sensitive Adhesive Layer]

The pressure-sensitive adhesive layer provides a pressure-sensitive adhesive surface that can be attached to an adherend and includes specific acrylic polymer as a resin component that ensures adhesion strength.

The pressure-sensitive adhesive layer that contains specific acrylic polymer described below reduces an amount of siloxane gas generated from the pressure-sensitive adhesive layer in a unit area after heating (after heating at 120° C. for ten minutes) to less than 20.0 ng/cm².

The acrylic polymer is included in 50% by mass or more (a lower limit value of a content rate), preferably 60% by mass or more, and more preferably 75% by mass or more, based on the total mass of the pressure-sensitive adhesive layer (100% by mass). An upper limit value of a content rate (% by mass) of the acrylic polymer is not particularly limited. The acrylic polymer is included in 100% by mass or less, preferably 99.9% by mass or less, more preferably 99% by mass or less, based on the total mass of the pressure-sensitive adhesive layer (100% by mass). The pressure-sensitive adhesive layer containing acrylic polymer within such a range is likely to have sufficient pressure-sensitive adhesion strength with respect to an adherend.

(alkyl(meth)acrylate)

The acrylic polymer is preferably contains at least one alkyl(meth)acrylate whose alkyl group being a linear or branched chain alkyl group with a carbon number of 1 to 18 (hereinafter, simply referred to as a alkyl(meth)acrylate) as a monomer unit (a monomer component) included in the acrylic polymer. The term “(meth)acrylic” refers to “acrylic” and/or “methacrylic,” (one of or both of “acrylic” and “methacrylic”) and the same is true for other descriptions.

The acrylic polymer containing an alkyl(meth)acrylate as the monomer unit is less likely to cause the pressure-sensitive adhesive layer to attract silicone therewith from the release liner when the release liner is separated from the pressure-sensitive adhesive layer.

The alkyl(meth)acrylate is included as a monomer unit (a lower limit value) in 70% by mass or more, preferably 75% by mass or more, and more preferably 80% by mass or more. The alkyl(meth)acrylate is included as a monomer unit (an upper limit value) in 97% by mass or less, preferably 95% by mass or less, and more preferably 93% by mass or less.

Examples of the alkyl(meth)acrylates include methyl(meth)acrylates, ethyl(meth)acrylates, propyl(meth)acrylates, isopropyl(meth)acrylates, n-butyl(meth)acrylates, isobutyl(meth)acrylates, s-butyl(meth)acrylates, t-butyl(meth)acrylates, pentyl(meth)acrylates, isopentyl(meth)acrylates, hexyl(meth)acrylates, heptyl(meth)acrylates, octyl(meth)acrylates, 2-ethylhexyl(meth)acrylates, isooctyl(meth)acrylates, nonyl(meth)acrylates, isononyl(meth)acrylates, decyl(meth)acrylates, isodecyl(meth)acrylates, undecyl(meth)acrylates, dodecyl(meth)acrylates (lauryl(meth)acrylates), tridecyl(meth)acrylates, tetradecyl(meth)acrylates, pentadecyl(meth)acrylates, hexadecyl(meth)acrylates, heptadecyl(meth)acrylates, octadecyl(meth)acrylates (stearyl(meth)acrylates), and iso stearyl(meth)acrylates. The (meth)acrylic alkyl esters can be used alone or in combination of two or more kinds.

The alkyl(meth)acrylate whose alkyl group being a linear or branched chain alkyl group with a carbon number of 4 to 18 is preferable since the amount of siloxane gas generated from the pressure-sensitive adhesive in a unit area after heating (after heating at 120° C. for ten minutes) is likely to be less than 10.0 ng/cm².

Both of the alkyl(meth)acrylate whose alkyl group being a linear or branched chain alkyl group with a carbon number of 6 to 8 and the alkyl(meth)acrylate whose alkyl group being a linear or branched chain alkyl group with a carbon number of 9 to 18 are preferably used as the alkyl(meth)acrylate in view of easily providing both of initial adhesive properties of the pressure-sensitive adhesive layer and workability of the pressure-sensitive adhesive layer.

(Non-Acidic Polar Monomers)

The acrylic polymer includes at least one polar group-containing monomer as a monomer unit (a monomer component) included in the acrylic polymer and the polar group-containing monomer is preferably made of only a non-acidic polar monomer that contains no acidic group as a polar group.

The polar group-containing monomer is a monomer including at least one kind of polar groups and having a polymerizable unsaturated bond (for example, a vinyl group). The polar group-containing monomers included in the acrylic polymer as a monomer unit are non-acidic polar monomers.

The non-acidic polar monomers are a kind of the polar group-containing monomers that include no acidic group (for example, a phosphoric acid group, a pyrophosphoric acid group, a thiophosphoric acid group, a phosphonic acid group, a carboxylic acid group, and a sulfonic acid group) as a polar group.

Examples of the non-acidic polar monomers include nitrogen-containing heterocyclic vinyl monomers, amide group-containing monomers, amino group-containing monomers, and hydroxyl group-containing monomers. The non-acidic polar monomers can be used alone or in combination of two or more kinds.

Examples of the nitrogen-containing heterocyclic vinyl monomers include N-vinyl-2-pyrolidone, (meth)acryloylmorpholine, N-vinylpiperidone, N-vinylpiperazine, N-vinylpyrrole, N-vinylimidazole, and N-vinyl caprolactam. The nitrogen-containing heterocyclic vinyl monomers can be used alone or in combination of two or more kinds.

Examples of the amide group-containing monomers include (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethylacrylamide. The amide group-containing monomers can be used alone or in combination of two or more kinds.

Examples of the amino group-containing monomers include aminoethyl(meth)acrylate, dimethylaminoethyl(meth)acrylate, and t-butylaminoethyl(meth)acrylate. The amino group-containing monomers can be used alone or in combination of two or more kinds.

Examples of the hydroxyl group-containing monomers include 2-hydroxyethyl(meth)acrylate, 3-hydroxypropyl(meth)acrylate, 4-hydroxybutyl(meth)acrylate, 6-hydroxyhexyl(meth)acrylate, vinyl alcohol, and allyl alcohol. The hydroxyl group-containing monomers can be used alone or in combination of two or more kinds.

The pressure-sensitive adhesive layer that includes the acrylic polymer including the non-acidic polar monomer as a monomer unit is likely to have sufficient pressure-sensitive adhesion strength with respect to the adherend and is less likely to attract silicone from the release liner and less likely to hold the silicone therewith.

The non-acidic polar monomer is included as a monomer unit (a lower limit value) in preferably 3% by mass or more, more preferably 7% by mass or more, and much more preferably 9% by mass or more. The pressure-sensitive adhesive layer including the non-acidic polar monomer having a content rate (% by mass) as a monomer unit within such a range is likely to have sufficient pressure-sensitive adhesion strength with respect to the adherend. The pressure-sensitive adhesive layer including the non-acidic polar monomer with the content rate (% by mass) as a monomer in 7% by mass or more has the 180° peel adhesion strength of 10 N/20 mm or more.

An upper limit value of the content rate of the non-acidic polar monomer as a monomer unit is not particularly limited. The non-acidic polar monomer is included as a monomer unit (an upper limit value) in preferably 30% by mass or less, preferably 25% by mass or less, and more preferably 18% by mass or less. The pressure-sensitive adhesive layer including the non-acidic polar monomer having a content rate (% b mass) as a monomer unit within such a range is likely to have sufficient pressure-sensitive adhesion strength with respect to the adherend. The pressure-sensitive adhesive layer including the non-acidic polar monomer with the content rate (% by mass) as a monomer in 18% by mass or less is likely to keep the amount of siloxane gas generated in a unit area of the pressure-sensitive adhesive layer after heating (after heating at 120° C. for ten minutes) less than 1.0 ng/cm².

(Other Monomers)

The acrylic polymer may further contain any other monomers that are copolymerizable with the alkyl(meth)acrylate as a monomer unit as long as the object of the present invention can be achieved. Examples of such monomers include multifunctional monomers having at least two or more polymerizable functional groups such as unsaturated double bonds (hereinafter, referred to as multifunctional monomers).

Examples of the multifunctional monomers include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylates, polyester acrylates, and urethane acrylates. The multifunctional monomers can be used alone or in combination of two or more kinds.

Examples of the other monomers include the amino group-containing monomers such as aminoethyl(meth)acrylate, dimethylaminoethyl(meth)acrylate, and t-butylaminoethyl(meth)acrylate; epoxy group-containing monomers such as glycidyl(meth)acrylate and methylglycidyl(meth)acrylate; imide group-containing monomers such as cyclohexylmaleimide and isopropylmaleimide; isocyanate group-containing monomers such as 2-methacryloyloxyethyl isocyanate; vinyl esters such as vinyl acetate and vinyl propanate; aromatic vinyl compounds such as styrene, and vinyltoluene; olefins or dienes such as ethylene, butadiene, isoprene, and isobutylene; vinyl ethers such as vinyl alkyl ethers; and vinyl chloride. The monomers can be used alone or in combination of two or more kinds.

The acrylic polymer can be produced by a known polymerization method (technique). Examples of the polymerization method include solution polymerization, emulsion polymerization, mass polymerization, and photopolymerization. The acrylic polymer is preferably produced by curing reaction with heat or active energy ray (for example, ultraviolet ray) by using a polymerization initiator such as a thermal polymerization initiator or a photopolymerization initiator. The curing reaction with using a photopoymerization initiator is preferable since polymerization time is shortened and an amount of outgas (for example, unreacted monomer or solvent) generated from the pressure-sensitive adhesive layer is reduced.

For example, the acrylic polymer is produced by irradiating a monomer composition including the photoppolymerization initiator with active energy ray (for example, ultraviolet ray) so that the monomer is polymerized. When producing the acrylic polymer, other components to be included in the pressure-sensitive adhesive layer and the polymerization initiator may be mixed. The thermal polymerization initiators or the photopolymerization initiators can be used alone or in combination of two or more kinds.

Examples of the thermal polymerization initiators include azo initiators [such as 2,2′-azobisisobutyronitrile, 2,2′-azobis-2-methylbutyronitrile, dimethyl2,2′-azobis(2-methylpropionate), 4,4′-azobis-4-cyanovalerianic acid, azobis isovaleronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, and 2,2′-azobis(N,N′-dimethyleneisobutylamidine)dihydrochloride], peroxide polymerization initiators (such as dibenzoyl peroxide, t-butyl permaleate), lauroyl peroxide), and redox polymerization initiators. The use amount of the thermal polymerization initiators is not particularly limited but may be within a range so as to be conventionally used as the thermal polymerization initiator.

The photopolymerization initiator is not particularly limited but may be a benzoin ether photopolymerization initiator, acetophenone photopolylmerization initiator, α-ketol photopolymerization initiator, aromatic sulfonyl chloride photopolymerization initiator, photoactive oxime photopolymerization initiator, benzoin photopolymerization initiator, benzyl photopolymerization initiator, benzophenone photopolymerization initiator, ketal photopolymerization initiator, thioxanthone photopolymerization initiator, and acylphosphine oxide photopolymerization initiator.

Examples of the benzoin ether photopolymerization initiator include benzoin methyl ether, benzoin ethyl ether, benzoin propyl ether, benzoin isopropyl ether, benzoin isobutyl ether, 2,2-dimethoxy-1,2-diphenylethane-1-one [product name: IRGACURE 651 supplied by BASF], and anisole methylether.

Examples of the acetophenone photopolymerization initiator include 1-hydroxycyclohexyl phenyl ketone [product name: IRGACURE 184 supplied by BASF], 4-phenoxy dichloroacetophenone, 4-t-butyl-dichloroacetophenone, 1-[4-(2-hydroxyethoxy)-phenyl]-2-hydroxy-2-methyl-1-propane-1-one [product name IRGACURE 2959 supplied by BASF], 2-hydroxy-2-methyl-1-phenyl-propane-1-one [product name: DAROCUR 1173 supplied by BASF], and methoxy acetophenone. Examples of the α-ketol photopolymerization initiator include 2-methyl-2-hydroxy propiophenone and 1-[4-(2-hydroxyethyl)-phenyl]-2-hydroxy-2-methylpropane-1-one.

Examples of the aromatic sulfonyl chloride photopolymerization initiator include 2-naphthalene sulfonyl chloride. Examples of the photoactive oxime photopolymerization initiator include 1-phenyl-1,1-propanedione-2-(o-ethoxycarbonyl)-oxime. Examples of the benzoin phoeopolymerization initiator include benzoin. Examples of the benzyl photopolymerization initiator include benzyl. Examples of the benzophenone photopolymerization initiator include benzophenone, benzoylbenzoic acid, 3,3′-dimethyl-4-methoxybenzophenone, polyvinyl benzophenone, and α-hydroxy cyclohexyl phenyl ketone. Examples of the ketal photopolymerization initiator include benzyl dimethyl ketal. Examples of thioxanthone photopolymerization initiator include thioxanthone, 2-chlorothioxanthone, 2-methyl thioxanthone, 2,4-dimethyl thioxanthone, isopropyl thioxanthone, 2,4-dichloro thioxanthone, 2,4-diethyl thioxanthone, isopropyl thioxanthone, 2,4-diisopropyl thioxanthone, and dodecyl thioxanthone.

Examples of the acylphosphine photopolymerization initiator include bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butyl phosphine oxide, bis(2,6-dimethoxybenzoyl)-(2-methylpropane-1-yl)phosphine oxide, bis(2,6-dimethoxybenzoyl)-(1-methylpropane-1-yl)phosphine oxide, bis(2,6-dimethosybenzoyl)-t-butylphosphine oxide, bis(2,6-dimethoxybenxoyl)cyclohexylphosphine oxide, bos(2,6-dimethoxybenzoyl)octylphosphine oxide, bis(2-methoxybenzoyl)(2-methylpropane-1-y)phospnine oxide, bis(2-methoxybenxoyl)(1-methylpropane-1-yl)phosphine oxide, bis(2,6-dimethoxybenzoyl)(2-methylpropane-1-yl)phosphine oxide, bis(2,6-diethoxybenzoyl)(1-methylpropane-1-yl)phosphine oxide, bis(2,6-dibutoxybenzoyl)(2-methylpropane-1-yl)phosphine oxide, bis(2,4-dimethoxybenzoyl)(2-methypropane-1-yl)phosphine oxide, bis(2,4,6-trimethylbenzoyl)(2,4-dipentoxyphenyl)phosphine oxide, bis(2,6-dimethoxybenzoyl)benzylphosphine oxide, bis(2,6-dimethoxybenzoyl)-2-phenylpropyl phosphine oxide, bis(2,6-dimethoxybenzoyl)2-phenylethyl phosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphine oxide, bis(2,4,6-trimethyl benzoyl)-2,4-di-n-butoxy phenylphosphine oxide, 2,4,6-trimethylbenzoyl diphenylphosphine oxide, bis(2,6-dimethoxybenzoyl)-2,4,4-trimethylpentylphoephine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoy)phosphine oxide.

The use amount of the photopolymerization initiator is not particularly limited as long as the acrylic polymer is produced by photopolymerization reaction. For example, the use amount of the photopolymerization initiator is preferably 0.01 to 5% by mass, more preferably 0.03 to 3% by mass, much more preferably 0.05 to 2%by mass, based on 100% by mass of the entire monomer used to produce the acrylic polymer. The photopolymerization initiator having the use amount of the above range provides sufficient polymerization reaction and the molecular weight of the generated polymer is less likely to be decreased. As a result, a sufficient cohesive force of the pressure-sensitive adhesive layer to be formed is provided.

It is important to irradiate the monomer component including the photopolymerization initiator with active energy rays to activate the photopolymerization initiator. Examples of the active energy rays include ionizing radiation such as α-rays, β-rays, γ-rays, neutron rays, and electron rays and ultraviolet rays. Particularly, ultraviolet rays are preferable. The irradiation energy, the irradiation time, and the irradiation method of the active energy rays are not particularly limited but may be set as appropriate as long as it activates the photopolymerization initiator and causes reaction of the monomer component.

The weight-average molecular weight (Mw) of the acrylic polymer may be in the range of 100,000 to 5,000,000. The weight-average molecular weight of the acrylic polymer is measured by gel permeation chromatography (GPC) in terms of polystyrene. Specifically, two columns of TSKge1GMH-H(20) are prepared and the weight-average molecular weight is measured by HPLC8020 supplied by TOSOH CORPORATION with using tetrahydrofuran as the solvent at flow velocity of 0.5 ml/min.

The pressure-sensitive adhesive layer may include following additives as long as the object of the invention is achieved. Examples of the additives include metal powders such as copper, nickel, aluminum, chrome, iron, and stainless, a carbonate such as calcium carbonate (for example, heavy calcium carbonate, light calcium carbonate), magnesium carbonate, sodium carbonate, and potassium carbonate, hydroxide such as aluminum hydroxide, and magnesium hydroxide, talc, mica, clay, bentonite, silica, alumina, aluminum silicate, titanium oxide, hollow microspheres, heat-expandable microspheres, and tackifier, crosslinking agents (for example, epoxy crosslinking agents, isocyanate cros slinking agents, silicone crosslinking agents, oxazoline crosslinking agents, aziridine crosslinking agents, silane crosslinking agents, alkylether melamine crosslinking agents, and metal chelate crosslinking agents), crosslinking accelerators, plasticizers, softening agents, antistatic agents, solvents, polymer, and adhesive agents (for example, rubber-based adhesive agents, vinyl alkyl ether-based adhesive agents, silicone-based adhesive agents, polyester-based adhesive agents, polyamide-based adhesive agents, urethane-based adhesive agents, fluorine-based adhesive agents, and epoxy-based adhesive agents). The additives can be included alone or in combination of two or more kinds.

(Thickness of Pressure-Sensitive Adhesive Layer)

The thickness of the pressure-sensitive adhesive layer is not particularly limited as long as the object of the present invention is achieved. For example, the pressure-sensitive adhesive layer preferably has a thickness (a lower limit value) of 1 μm or more, and more preferably 5 μm or more. The pressure-sensitive adhesive layer preferably has a thickness (an upper limit value) of 500 μm or less, and more preferably 250 μm or less. The pressure-sensitive adhesive sheet including the pressure-sensitive adhesive layer having the thickness in the above range can have sufficient adhesion strength.

(Method of Making Pressure-Sensitive Adhesive Layer)

The pressure-sensitive adhesive layer is made by using an adhesive composition. The adhesive composition is not particularly limited as long as the above pressure-sensitive adhesive layer is made and is selected as appropriate for a purpose. The adhesive composition is preferably a curing adhesive composition that includes a mixture of a monomer composition including a monomer for forming the acrylic polymer, a polymerization initiator for polymerizing the monomer, and other components that are added as necessary, in view of workability.

The adhesive composition is preferably a photocurable adhesive composition that includes a photopolymerization initiator as a polymerization initiator. The photocurable adhesive composition is a so-called solventless adhesive composition and prepared by mixing a polymerization initiator with the monomer composition.

The monomer composition may be a mixture of alkyl(meth)acrylate and a monomer such as a non-acidic polar monomer, for example. The monomer composition is normally in a liquid state although it depends on the kind or a composition ratio of the monomers. The monomer included in the monomer composition may be partially polymerized to form a partial polymer so that the viscosity of the monomer composition is increased to improve workability (handling properties). The monomer composition including the partial polymer is in a state of syrup. The unreacted monomer component in the monomer composition is polymerized as appropriate.

The polymerization of the partial polymer is performed by known polymerization methods. For example, the monomer included in the monomer composition may be polymerized as appropriate by using any of the polymerizing initiators (for example, a photopolymerization initiator) that are described in the above method of producing the acrylic polymer. A conversion rate (a polymerization ratio) of the partial polymer is 5 to 15% by mass, and preferably 7 to 10% by mass. The conversion rate of the partial polymer is adjusted by adjusting the viscosity of the monomer composition based on a correlation between the viscosity of the monomer composition and the conversion rate of the partial polymer. The partial polymer is finally included in the pressure-sensitive adhesive layer as a part of the acrylic polymer.

The multifunctional monomer may be mixed with the monomer composition before the formation of the partial polymer or may be mixed with the monomer composition after the formation of the partial polymer when the multifunctional monomer is used as a monomer compound for making the acrylic polymer. The multifunctional monomer is preferably mixed with the monomer composition after the formation of the partial polymer so that the crosslinking type acrylic polymer is produced and the cohesion properties of the pressure-sensitive adhesive layer are surely improved.

The produced curing adhesive composition is applied on (with coating) a support such as a base or a release liner in a form of a layer. Thereafter, the adhesive composition layer (coated film) is subjected to a curing process. The adhesive composition layer may be subjected to a drying process before or after the curing process as necessary.

The adhesive composition including the thermal polymerization initiator as the polymerization initiator is cured by starting the polymerization reaction by heating. The adhesive composition including the photopolymerization initiator as the polymerization initiator is cured (photocured) by starting the polymerization reaction by application of active energy rays such as ultraviolet rays. The active energy rays may be applied to one surface or both surfaces of the adhesive composition layer (coating film). The adhesive composition is thus cured and the pressure-sensitive adhesive layer that can be used for the pressure-sensitive adhesive sheet is obtained.

The adhesive composition may be processed with a known oxygen blocking method such that the polymerization reaction is not hindered by oxygen in air during the curing (photocuring) by the active energy rays. For example, oxygen is blocked by providing an appropriate support such as a release liner or a base on the adhesive composition layer (the pressure-sensitive adhesive layer) or carrying out the photocuring reaction in nitrogen atmosphere.

The adhesive composition is applied (coating) with known coating methods with using known coaters (for example, a gravure coater, a reverse coater, a kiss roll coater, a dip roll coater, a bar coater, a knife coater, a spray coater, a comma coater, and a direct coater.

The pressure-sensitive adhesive layer may be made of adhesive compositions other than the above curing-type adhesive compositions (for example, solvent-type adhesive compositions, and emulsion-type adhesive compositions).

(Amount of Generated Siloxane Gas)

In the pressure-sensitive adhesive layer from which the release liner is separated, the amount (a generation amount) of siloxane gas generated in a unit area after heating at 120° C. for ten minutes is less than 20.0 ng/cm².

In this specification, the target siloxane gas is low molecular cyclic siloxane containing a trimer (D3), a tetramer (D4), a pentamer (D5), or hexamer (D6). Such low molecular cyclic siloxane is likely to cause detection errors in the precision electronic devices such as a hard disk drive. The amount of generated siloxane gas is measured by the dynamic head space method, which will be described later. “In a unit area of the pressure-sensitive adhesive layer” means “in a unit area of an adhesive surface of the pressure-sensitive adhesive layer”.

If the amount of siloxane gas generated from the pressure-sensitive adhesive layer is less than 20.0 ng/cm², the pressure-sensitive adhesive sheet including such a pressure-sensitive adhesive layer is effectively used in a situation where generation of siloxane gas is not desired such as the hard disc drive.

The amount of siloxane gas generated from the pressure-sensitive adhesive layer is preferably less than 10.0 ng/cm², and more preferably less than 1.0 ng/cm².

(Amount of Generated Outgas)

In the pressure-sensitive adhesive layer from which the release liner is separated, the amount (the generation amount) of outgas (excluding siloxane gas) generated in a unit area after heating at 120° C. for ten minutes is preferably less than 500 ng/cm².

The target outgas in this specification is any gas generated from the pressure-sensitive adhesive layer other than the siloxane gas. The outgas mainly includes unreacted monomers, solvents, water generated from the pressure-sensitive adhesive layer. The generation amount of the outgas is measured by the dynamic head space method which will be described later. “In a unit area of the pressure-sensitive adhesive layer” means “in a unit area of an adhesive surface of the pressure-sensitive adhesive layer”.

If the amount of outgas generated from the pressure-sensitive adhesive layer is less than 500 ng/cm², the pressure-sensitive adhesive sheet including such a pressure-sensitive adhesive layer is effectively used in a situation where generation of siloxane gas is not desired such as the hard disc drive.

(Base)

The base that may be layered on the pressure-sensitive adhesive layer as necessary may be made of plastic, paper, fibers (a woven cloth, a nonwoven cloth), and metal. A plastic film base is preferably used as the base.

A plastic film base made of engineering plastic may be preferably used as the plastic film base. Materials used for the plastic film base may include polyester [polyethylene terephthalate (PET), polyethylene naphthalate (PEN), and polybutylene terephthalate (PBT)], olefin resins [olefin resins including α-olefin such as polyethylene (PE), polypropylene (PP), ethylene-propylene copolymer, and ethylene-vinyl acetate copolymer (EVA) as a monomer component], polyether sulfone (PES), polysulfone, polyvinyl chloride (PVC), polyphenylene sulfide (PPS), amide resins [polyamide (nylon), wholly aromatic polyamide (aramid)], polyimide (PI), polyamideimide, polyether imide (PEI), polyester imide, methacrylate resins [polymethyl methacrylate (PMMA)], styrene resins [polystyrene, acrylonitrile-styrene copolymer (AS resin), and acrylonitrile-butadiene-styrene copolymer (ABS resin)], polycarbonate (PC), polyacetal, polyarylene ether (polyphenylene ether), polyphnylene sulfide, polyarylate, polyaryl, polyurethane, polyether ketones [polyether ether ketone (PEEK), .polyether ketone ketone], polyacrylic esters (polyacrylic butyl, polyacrylic ethyl), and epoxy resins. The materials used for the plastic film base can be used alone or in combination of two or more.

The plastic film base made of polyester (preferably polyethylene terephthalate) is preferably used in view of the thickness precision, tensile strength, and workability.

A surface of the base (particularly a surface of the plastic film base) may be subjected to a known surface treatment, for example, a chemical or physical treatment, such as chromic acid treatment, ozone exposure, flame exposure, high-pressure electrical-shock exposure, and ionization radiation treatment, or may be coated with a primer. For example, the surface of the base may be subjected to the surface treatment to improve adhesion between the surface of the base and the pressure-sensitive adhesive layer disposed on the base.

The base may be a single layer or may be composed of multiple layers and may not be limited.

The base preferably has a thickness (a total thickness) of 10 μm to 110 μm. The thickness is not limited but may be determined as appropriate for a purpose.

(Release Liner)

In the pressure-sensitive adhesive sheet before use, an adhesive surface of the pressure-sensitive adhesive layer is protected by a release liner. The release liner includes the release layer made of the silicone releasing agent and the support base supporting the release layer, as described before. The release liner is attached so that the release layer is on the pressure-sensitive adhesive layer. The release layer may be formed on one surface or both surfaces of the support base to be layered on the pressure-sensitive adhesive layer.

(Support Base)

Materials of the support base (a release liner base) supporting (holding) the release layer are not particularly limited. For example, the support base may be a single layer or multiple layers made of plastic, paper, or fibers.

The plastic base may be a film base made of polyolefin such as polyethylene (PE) and polypropylene (PP); polyester such as polyethylene terephthalate (PET), polyethylene naphthalate (PEN), and polybutylene terephthalate (PBT); polyamide (so-called nylon); and cellulose (so-called cellophane). The plastic film may be a non-stretched film or a stretched film (a uniaxially stretched type or a biaxial stretched type).

A paper base may be made of Japanese papers, western papers, fine quality papers, glassine papers, kraft papers, Culpak papers, crepe papers, clay coat papers, top coat papers, and synthetic papers. The weight of the paper base is not particularly limited but may be preferably in a range of 50 g/m² to 100 g/m².

A fiber base may be made of fiber materials such as a natural fiber, a semisynthetic fiber, and a synthetic fiber. Examples of the fiber materials include a cotton fiber, spun rayon, Manila hemp, pulp, rayon, an acetate fiber, a polyester fiber, a polyvinyl alcohol fiber, a polyamide fiber, and a polyolefin fiber. The fiber materials can be used in alone or with mixing two or more kinds in a woven cloth or an unwoven cloth.

A base made of other materials may include a rubber sheet made of rubber such as natural rubber and butyl rubber; a foamed sheet made of foamed material such as foamed polyurethane and foamed polychloroprene rubber; metal foil such as aluminum foil and copper foil; and composite thereof.

The support base (a release liner base) may be subjected to surface modification processes such as a corona discharge treatment, a plasma treatment, and coating of undercoating agents or surface processes such as embossing on a surface thereof having a releasing layer as necessary. The support base may include additives such as fillers (nonorganic fillers, organic fillers), age inhibitors, antioxidants, ultraviolet ray absorbing agents, antistatic agents, lubricants, plasticizing agents, and colorants (such as pigments and dyes) as necessary.

The release liner may preferably have a thickness of 25 μm to 200 μm, and more preferably 38 μm to 160 μm.

(Release Layer)

The silicone release agents for the release layer may be conventionally known silicone release agents. Examples of such silicone release agents may include thermosetting silicone release agents that are cured by heat after coating, and ionizing radiation-curable silicone release agents that are cured by ionizing radiation (ultraviolet rays, α-rays, β-rays, γ-rays, neutron rays, and electron rays). The silicone release agents may be used alone or in combination of two or more kinds.

The silicone release agents may be solventless silicone release agents including no solvents or may be solvent-based silicone release agents wherein the silicone release agents are dissolved or dispersed in an organic solvent. The solventless silicone release agents may be mixed with a solvent having relatively low surface tension so that viscosity thereof is adjusted for easy application (coating). The silicone release agents may preferably be solventless silicone release agents that substantially do not include organic solvents and can be coated as it is.

The silicone release agents may include known additives as necessary as long as the object of the invention is achieved. Examples of the additives include fillers, antioxidants, antistatic agents, ultraviolet ray absorbing agents, plasticizing agents, and colorants (such as pigments and dyes).

The release layer made of the silicone release agents may be formed on the support base with known methods. For example, the silicone release agents may be coated and dried to form the release layer with using coaters. Examples of the coaters include a direct gravure coater, an offset gravure coater, a roll coater, a bar coater, and a die coater.

An application amount (a coating amount) (g/m²) of the release layer with respect to the support base may be determined as appropriate according to a kind of the acrylic polymer included in the pressure-sensitive adhesive layer, a kind of the support base, and a kind of the release agent. An upper limit value of the application amount of the release layer is preferably 0.15 g/m² or less, more preferably 0.12 g/m² or less, in terms of polydimethylsiloxane (in terms of solid content). A lower limit value of the application amount of the release layer is preferably 0.005 g/m² or more, more preferably 0.01 g/m² or more, in terms of polydimethylsiloxane (in terms of solid content). The release liner including the release layer of the application amount within such a range is surely separated from the pressure-sensitive adhesive layer and the amount of silicone transferred on the pressure-sensitive adhesive layer is reduced.

The release layer is dried after being applied on the support base with coating. Drying conditions are not particularly limited but may be determined appropriate for the release agent to be used. The release layer is generally dried at a temperature of 80° C. to 150° C. The release layer including the thermosetting silicone release agents may be dried with being heated so that the drying process and the curing process can be performed at the same time. The release layer may be heated to be cured after dried under natural conditions. The release layer including the ionizing radiation-curable silicone release agents may be irradiated with radiation with being heated so that the drying process and the curing process can be performed at the same time. The curing process may be performed after the drying process. The drying process and the curing process may be selected from the known processes as appropriate for the release agents to be used. The conditions for forming the release layer may be set as appropriate to achieve the target amount of silicone to be transferred.

The release layer may have a thickness that is determined as appropriate according to a kind of the acrylic polymer included in the pressure-sensitive adhesive layer, a kind of the support base, and a kind of the release agent. The release layer may have a thickness of an upper limit value (μm) being preferably 0.18 μm or less, and more preferably 0.15 μm or less. The release layer may have a thickness of a lower limit value (μm) being preferably 0.08 μm or more, and more preferably 0.10 μm or more. The release liner including the release layer having a thickness within such a range is surely separated from the pressure-sensitive adhesive layer and the amount of silicone transferred on the pressure-sensitive adhesive layer is reduced.

The thickness of the release layer is determined based on an average value calculated from the values obtained five points of the release layer with using the scanning electron microscope (SME).

(Transfer Amount of Silicone and Transfer Rate of Silicone)

Silicone contained in the silicone release agents is less likely to be transferred from the release layer to the pressure-sensitive adhesive layer even if the release liner including the release layer made of the silicone release agents is attached on the pressure-sensitive adhesive layer of the pressure-sensitive adhesive sheet.

In the pressure-sensitive adhesive sheet, when the release liner is separated from the pressure-sensitive layer, the amount of silicone transferred from the release layer to the pressure-sensitive adhesive layer (the transfer amount) is preferably 0.005 g/m² or less in a unit area in terms of polydimethylsiloxane.

“In a unit area” means “in a unit area of a portion of the pressure-sensitive adhesive sheet, the portion including the pressure-sensitive adhesive layer and the release liner being attached to each other”. “In a unit area” of the pressure-sensitive adhesive layer means “in a unit area of the adhesive surface of the pressure-sensitive adhesive layer”. “In a unit area” of the release liner means “in a unit area of a portion thereof having the release layer (a surface of the release layer)”. The transfer amount of silicone is obtained with a method using the fluorescence X-ray analysis, which will be described later.

When the release liner is separated from the pressure-sensitive adhesive layer in the pressure-sensitive adhesive sheet, the transfer rate (ratio) of silicone that is transferred from the release layer to the pressure-sensitive adhesive layer is preferably less than 30% by mass in terms of polydimethylsiloxane.

The rate of silicone transferred from the release layer of the release liner to the pressure-sensitive adhesive layer (transfer rate) is obtained by using results regarding the silicone transfer amount obtained by the fluorescence X-ray analysis.

(Amount of Generated Siloxane Gas)

In the pressure-sensitive adhesive sheet including the pressure-sensitive adhesive layer where the release liner including the release layer made of silicone release agents is attached, silicone contained in the silicone release agent is less likely to be transferred from the release layer to the pressure-sensitive adhesive layer. As a result, siloxane gas that may be generated due to the silicone release agent is less likely to be generated from the pressure-sensitive adhesive layer.

In the pressure-sensitive adhesive sheet, the pressure-sensitive adhesive layer from which the release liner is separated has the amount (the generation amount) of siloxane gas generated in a unit area after heating at 120° C. for ten minutes being less than 20.0 ng/cm².

In this specification, the target siloxane gas is low molecular cyclic siloxane containing a trimer (D3), a tetramer (D4), a pentamer (D5), or hexamer (D6). Such low molecular cyclic siloxane is likely to cause detection errors in the precision electronic devices such as a hard disk drive. The generation amount of siloxane gas is measured by the dynamic head space method, which will be described later. “In a unit area of the pressure-sensitive adhesive layer” means “in a unit area of an adhesive surface of the pressure-sensitive adhesive layer”.

If the amount of siloxane gas generated from the pressure-sensitive adhesive layer is less than 20.0 ng/cm², the pressure-sensitive adhesive sheet including such a pressure-sensitive adhesive layer is effectively used in a situation where generation of siloxane gas is not desired such as the hard disc drive.

The amount of siloxane gas generated from the pressure-sensitive adhesive layer is preferably less than 10.0 ng/cm², and more preferably less than 1.0 ng/cm².

(Amount of Generated Outgas)

In the pressure-sensitive adhesive layer from which the release liner is separated, the amount (the generation amount) of outgas (excluding siloxane gas) generated in a unit area after heating at 120° C. for ten minutes is preferably less than 500 ng/cm².

In this specification, the target outgas includes any gas generated from the pressure-sensitive adhesive layer other than the siloxane gas. The outgas mainly includes unreacted monomers, solvents, water generated from the pressure-sensitive adhesive layer. The generation amount of the outgas is measured by the dynamic head space method which will be described later. “In a unit area of the pressure-sensitive adhesive layer” means “in a unit area of an adhesive surface of the pressure-sensitive adhesive layer”.

If the amount of outgas generated from the pressure-sensitive adhesive layer is less than 500 ng/cm², the pressure-sensitive adhesive sheet including such a pressure-sensitive adhesive layer is effectively used in a situation where generation of siloxane gas is not desired such as the hard disc drive.

In the pressure-sensitive adhesive sheet including the base supporting the pressure-sensitive adhesive layer (for example, the pressure-sensitive adhesive sheet 1A, 1B), the amount of generated siloxane gas and the amount of generated outgas are measured by heating the pressure-sensitive adhesive sheet where the base is removed from the pressure-sensitive adhesive layer (only with the pressure-sensitive adhesive layer).

(180° Peel Adhesion Strength)

Desired adhesion strength of the pressure-sensitive adhesive layer of pressure-sensitive adhesive sheet may depend on the use and is not particularly limited. The adhesion strength is evaluated by the 180° peel adhesion strength (with respect to SUS) measured by the measurement method which will be described below.

The pressure-sensitive adhesive layer of the pressure-sensitive adhesive sheet has 180° peel adhesion strength (with respect to SUS) of preferably 6 N/20 mm or more.

The pressure-sensitive adhesive layer of the pressure-sensitive adhesive sheet has 180° peel adhesion strength (with respect to SUS) of more preferably 10 N/20 mm or more, and much more preferably 15 N/20 mm or more.

(Other Properties)

The pressure-sensitive adhesive sheet is excellent in workability (handleability), storage stability, durability, and followability (followability to difference in level). The pressure-sensitive adhesive sheet includes the silicone based release liner including the silicone release layer as the release liner is more excellent in the heat resisting properties and a cost compared to the one including the non-silicone based release liner.

(Use)

The pressure-sensitive adhesive sheet is preferably used in a situation where generation of siloxane gas is not desired. The pressure-sensitive adhesive sheet is preferably used, for example, for fixing electronic parts (electronic members) and parts (members) such as casing of a hard disc drive. If siloxane gas is generated within the hard disc drive or siloxane gas enters the hard disc drive, siloxane gas is oxidized to SiO₂ that may cause head crush. The hard disc drive using the pressure-sensitive adhesive sheet of this embodiment has quite high reliability since siloxane gas is less likely to be generated.

The pressure-sensitive adhesive sheet may be used for other purposes than fixing, and may be used for damping, sealing, and sound absorption. The pressure-sensitive adhesive sheet may be used as an indication label. The pressure-sensitive adhesive sheet may be preferably used in precision electronic devices other than the hard disc drive.

The pressure-sensitive adhesive sheet may be used for masking in painting where generation of siloxane gas is not desired.

A method of using the pressure-sensitive adhesive sheet in a precision electronic device includes a separating process where the release liner is separated from the pressure-sensitive adhesive layer and an attachment process where the pressure-sensitive adhesive layer is attached to a component of the precision electronic device.

The pressure-sensitive adhesive sheet includes a pressure-sensitive adhesive layer including an acrylic polymer, and a release liner including a release layer made of a silicone release agent, the release layer being applied on the pressure-sensitive adhesive layer. The acrylic polymer includes at least one alkyl(meth)acrylate whose alkyl group being a linear or branched chain alkyl group with a carbon number of 1 to 18 as a monomer unit, and an amount of siloxane gas generated in a unit area of the pressure-sensitive adhesive layer where the release liner is removed is less than 20.0 ng/cm² after heating at 120° C. for ten minutes.

In the pressure-sensitive adhesive sheet, an amount of outgas (except for the siloxane gas) generated in a unit area of the pressure-sensitive adhesive layer where the release liner is removed may be less than 500 ng/cm² after heating at 120° C. for ten minutes.

In the pressure-sensitive adhesive sheet, the release layer may be made of a silicone release agent with an amount of 0.15 g/m² or less in a unit area in terms of polydimethylsiloxane.

In the pressure-sensitive adhesive sheet, when the release liner is separated from the pressure-sensitive adhesive layer, an amount of silicone transferred from the release layer to the pressure-sensitive adhesive layer may be 0.005 g/m² or less in a unit area in terms of polydimethylsiloxane.

In the pressure-sensitive adhesive sheet, when the release liner is separated from the pressure-sensitive adhesive layer, an rate of silicone transferred from the release layer to the pressure-sensitive adhesive layer may be less than 30% by mass in terms of polydimethylsiloxane.

In the pressure-sensitive adhesive sheet, the acrylic polymer may include at least one monomer containing a polar group as a monomer unit, and the at least one monomer containing the polar group may include only a non-acidic polar monomer including no acidic group as the polar group.

In the pressure-sensitive adhesive sheet, the non-acidic polar monomer may be included as a monomer unit (% by mass) is 3% by mass or more based on a total amount of the monomer unit (100% by mass).

In the pressure-sensitive adhesive sheet, the alkyl(meth)acrylate may include a linear or branched chain alkyl group with a carbon number of 4 to 18.

In the pressure-sensitive adhesive sheet, the pressure-sensitive adhesive layer may have 180° peel adhesion strength of 10 N/20 mm or more.

The pressure-sensitive adhesive sheet may be used in a precision electronic device.

A method of using the pressure-sensitive adhesive sheet in a precision electronic device may include separating the release liner from the pressure-sensitive adhesive layer, and attaching the pressure-sensitive adhesive layer on a part of the precision electronic device.

A precision electronic device may include the pressure-sensitive adhesive sheet.

According to an aspect of the present invention, the problems of known pressure-sensitive adhesive sheets can be resolved and it is provided a pressure-sensitive adhesive sheet where siloxane gas is less likely to be generated from the pressure-sensitive adhesive layer even with using a silicone based release liner.

According to another aspect of the present invention, a method of using a pressure-sensitive adhesive sheet in a precision electronic device such as a hard disk drive is provided.

According to another different aspect of the present invention, a precision electronic device such as a hard disk drive including the pressure-sensitive adhesive sheet is provided.

### EXAMPLES

Hereinafter, the present invention will be described based on examples. The present invention is not limited to the examples.

### Example 1

(Production of Syrup)

A liquid monomer mixture (a monomer composition) was prepared by mixing 10 parts by mass of N-vinyl-2-pyrolidone (NVP) and 90 parts by mass of methyl acrylate (MA). As a photopolymerization initiator, 0.05 parts by mass of “IRGACURE 651 (2,2-dimethoxy-1,2-diphenylethane-1-one)” supplied by BASF Japan LTD.) and 0.05 parts by mass of “IRGACURE 184 (hydroxyl cyclohexyl phenyl ketone)” supplied by BASF Japan LTD.) were mixed with the liquid monomer mixture, followed by application of ultraviolet rays until the viscosity is approximately 20 Pa·s (a BH viscometer, a No. 5 rotor, 10 rpm, a measurement temperature: 30° C.). Thus, syrup (NVP/MA=90/10) containing a partial polymer obtained by partially polymerizing a part of the monomer component was obtained.

The syrup (100 parts by mass) was mixed with 0.05 parts by mass of dipentaerythritol hexa(meth)acrylate (DPHA, product name “KAYARAD” supplied by Nippon Kayaku Co., Ltd.) as a crosslinking component (multifunctional monomer). Then, the syrup was sufficiently mixed and an adhesive composition was obtained.

(Release Liner)

A release liner (a release liner A) was prepared by applying a release layer made of the silicone release agents having a thickness of 0.1 μm on a surface of the support base made of PET (thickness: 75 μm). The release layer was prepared as follows. The surface of the support base was coated with the silicone release agent at an amount of 0.10 g/m² and the coated silicone release agent was heated at 120° C. for one minute to be dried and cured.

(Production of Pressure-Sensitive Adhesive Sheet)

A pair of release liners A was prepared. The adhesive composition was applied on a release processed surface (release processed with the silicone release agent) of one of the release liners A so that a thickness after curing will be 50 μm and thus a coating layer was obtained. Another one of the release liners A is attached to the coating layer with a release processed surface (release processed with the silicone release agent) of the other release liner A being opposite the coating layer.

Next, the ultraviolet rays having an illuminance of 5 mW/cm² were applied to both surfaces of the coating layer through the release liners A for two minutes so that the coating layer is cured. Thus, the pressure-sensitive adhesive layer having a thickness of 50 μm was obtained. “Blacklight” supplied by TOSHIBA CORPORATION was used as a generator of the ultraviolet rays. The illuminance of the ultraviolet rays was adjusted by using an UV checker (“UVR-T1” supplied by TOPCON CORPORATION, maximum sensitivity; measured at 350 nm).

Thus, the pressure-sensitive adhesive sheet (a double-sided pressure-sensitive adhesive sheet without a base) according to Example 1 was obtained.

### Example 2

An adhesive composition and other components were produced in the same manner as Example 1, except for using 90 parts by mass of ethyl acrylate (EA) instead of using 90 parts by mass of methyl acrylate (MA). Thus, a pressure-sensitive adhesive sheet according to Example 2 was obtained.

### Example 3

An adhesive composition and other components were produced in the same manner as Example 1, except for using 90 parts by mass of butyl acrylate (BA) instead of using 90 parts by mass of methyl acrylate (MA). Thus, a pressure-sensitive adhesive sheet according to Example 3 was obtained.

### Example 4

An adhesive composition and other components were produced in the same manner as Example 1, except for using 90 parts by mass of 2-ethylhexyl(meth)acrylate (2EHA) instead of using 90 parts by mass of methyl acrylate (MA). Thus, a pressure-sensitive adhesive sheet according to Example 4 was obtained.

### Example 5

An adhesive composition and other components were produced in the same manner as Example 1, except for using 90 parts by mass of isooctyl acrylate (iOA) instead of using 90 parts by mass of methyl acrylate (MA). Thus, a pressure-sensitive adhesive sheet according to Example 5 was obtained.

### Example 6

An adhesive composition and other components were produced in the same manner as Example 1, except for using 90 parts by mass of isononyl acrylate (iNA) instead of using 90 parts by mass of methyl acrylate (MA). Thus, a pressure-sensitive adhesive sheet according to Example 6 was obtained.

### Example 7

An adhesive composition and other components were produced in the same manner as Example 1, except for using 90 parts by mass of lauryl acrylate (LA) instead of using 90 parts by mass of methyl acrylate (MA). Thus, a pressure-sensitive adhesive sheet according to Example 7 was obtained.

### Example 8

An adhesive composition and other components were produced in the same manner as Example 1, except for using 90 parts by mass of isostearyl acrylate (iSTA) instead of using 90 parts by mass of methyl acrylate (MA). Thus, a pressure-sensitive adhesive sheet according to Example 8 was obtained.

### Example 9

An adhesive composition and other components were produced in the same manner as Example 1, except for using 45 parts by mass of stearyl acrylate (STA) and 45 parts by mass of 2-ethylhexyl(meth)acrylate (2EHA) instead of using 90 parts by mass of methyl acrylate (MA). Thus, a pressure-sensitive adhesive sheet according to Example 9 was obtained.

### Example 10

An adhesive composition and other components were produced in the same manner as Example 1, except for using 45 parts by mass of isostearyl acrylate (iSTA) and 45 parts by mass of 2-ethylhexyl(meth)acrylate (2EHA) instead of using 90 parts by mass of methyl acrylate (MA). Thus, a pressure-sensitive adhesive sheet according to Example 10 was obtained.

### Example 11

An adhesive composition and other components were produced in the same manner as Example 4, except for changing the amount of N-vinyl-2-pyrolidone (NVP) to 5 parts by mass and changing the amount of 2-ethylhexyl(meth)acrylate (2EHA) to 95 parts by mass. Thus, a pressure-sensitive adhesive sheet according to Example 11 was obtained.

### Example 12

An adhesive composition and other components were produced in the same manner as Example 4, except for changing the amount of N-vinyl-2-pyrolidone (NVP) to 15 parts by mass and changing the amount of 2-ethylhexyl(meth)acrylate (2EHA) to 85 parts by mass. Thus, a pressure-sensitive adhesive sheet according to Example 12 was obtained.

### Example 13

An adhesive composition and other components were produced in the same manner as Example 4, except for changing the amount of N-vinyl-2-pyrolidone (NVP) to 20 parts by mass and changing the amount of 2-ethylhexyl(meth)acrylate (2EHA) to 80 parts by mass. Thus, a pressure-sensitive adhesive sheet according to Example 13 was obtained.

### Comparative Example 1

An adhesive composition and other components were produced in the same manner as Example 1, except for using 100 parts by mass of acrylic acid (AA) instead of using 10 parts by mass of N-vinyl-2-pyrolidone (NVP) and using 90 parts by mass of 2-ethylhexyl(meth)acrylate (2EHA) instead of using 90 parts by mass of methyl acrylate (MA). Thus, a pressure-sensitive adhesive sheet according to Comparative Example 1 was obtained.

### Comparative Example 2

An adhesive composition and other components were produced in the same manner as Example 1, except for using 100 parts by mass of acrylic acid (AA) instead of using 10 parts by mass of N-vinyl-2-pyrolidone (NVP) and using 90 parts by mass of isooctyl acrylate (iOA) instead of using 90 parts by mass of methyl acrylate (MA). Thus, a pressure-sensitive adhesive sheet according to Comparative Example 2 was obtained.

### Comparative Example 3

An adhesive composition and other components were produced in the same manner as Example 1, except for using 100 parts by mass of acrylic acid (AA) instead of using 10 parts by mass of N-vinyl-2-pyrolidone (NVP) and using 90 parts by mass of isononyl acrylate (iNA) instead of using 90 parts by mass of methyl acrylate (MA). Thus, a pressure-sensitive adhesive sheet according to Comparative Example 3 was obtained.

### Example 14

A pressure-sensitive adhesive sheet according to Example 14 was produced in the same manner as Example 4, except for using release liners B, which will be described below, instead of using the release liners A. The release liner B was prepared by applying a release layer made of the silicone release agents having a thickness of 0.14 μm on a surface of the support base made of PET (thickness: 75 μm). The release layer was prepared as follows. The surface of the support base was coated with the silicone release agent at an amount of 0.143 g/m² and the coated silicone release agent was heated at 120° C. for one minute to be dried and cured.

### Comparative Example 4

A pressure-sensitive adhesive sheet according to Comparative Example 4 was produced in the same manner as Example 4, except for a structure of the release liner A including only the support base (made of PET, thickness: 75 μm).

### Comparative Example 5

A pressure-sensitive adhesive sheet according to Comparative Example 5 was produced in the same manner as Example 4, except for using release liners C, which will be described below, instead of using the release liners A. The release liner C was prepared by applying a release layer made of the silicone release agents having a thickness of 0.22 μm on a surface of the support base made of PET (thickness: 75 μm). The release layer was prepared as follows. The surface of the support base was coated with the silicone release agent at an amount of 0.215 g/m² and the coated silicone release agent was heated at 120° C. for one minute to be dried and cured.

### Comparative Example 6

A pressure-sensitive adhesive sheet according to Comparative Example 6 was produced in the same manner as Example 4, except for using release liners D, which will be described below, instead of using the release liners A. The release liner D was prepared by applying a release layer made of the silicone release agents having a thickness of 0.51 μm on a surface of the support base made of PET (thickness: 75 μm). The release layer was prepared as follows. The surface of the support base was coated with the silicone release agent at an amount of 0.505 g/m² and the coated silicone release agent was heated at 120° C. for one minute to be dried and cured.

[Evaluation]

The following evaluation tests were carried out on the pressure-sensitive adhesive sheets of Examples and Comparative Examples.

[Evaluation 1: Amount of Generated Gas (Siloxane Gas and Other Outgas)]

The pressure-sensitive adhesive sheet was cut into a piece having a size of 7 cm² and the release liner was removed from the piece of the pressure-sensitive adhesive sheet and provided as a test sample. The test sample was heated in the headspace sampler at 120° C. for ten minutes. An amount of gas generated from the test sample was measured by using the gas chromatograph/mass spectrometer (GC-MS). The target gas to be measured is siloxane gas (cyclic siloxane: a trimer D3, a tetramer D4, a pentamer D5, or hexamer D6) and other outgas. The amount of generated outgas is calculated by subtracting the amount of generated siloxane gas from a total amount of generated gas. The amount of siloxane gas and the amount of outgas correspond to the amount of gas generated in a unit area of the pressure-sensitive adhesive sheet (ng/cm²). The results are indicated in Tables 1 and 2.

Measurement conditions of the dynamic headspace method (device) used for measuring the amount of generated gas are as follows. The headspace auto sampler (product name “EQ-12031HSA” supplied by JEOL Ltd. was used as the auto sampler. A sample was put in a vial of 50 ml and heated at 120° C. for ten minutes. The amount of gas generated from the sample was measured by using the gas chromatograph/mass spectrometer (GC-MS). Product name “JMS-Q1000GC” supplied by JEOL Ltd. was used as the GC-MS.

[Evaluation 2: Transfer Amount of Silicone and Transfer Rate of Silicone]

One release liner was separated from the pressure-sensitive adhesive sheet and a PET film having a thickness of 50 μm was attached thereto for backing. The backed pressure-sensitive adhesive sheet was cut into a square shape having a size of 50 mm by 50 mm and provided as a test sample. The test sample was kept in a dryer at a temperature of 70° C. with a load of 5 kg for twenty four hours. Subsequently, the load was removed from the test sample and taken out from the dryer and kept at a temperature of 23° C. for two hours. Then, another release liner was separated from the test sample. The amount of Si in a circular area having 30 mm in diameter of an uncovered adhesive surface of the test sample and the amount of Si in a circular area having 30mm in diameter of a release processed surface (a surface of the release layer) of the separated release liner were measured by the fluorescence X-ray analysis device as the intensity of X-rays (cps: counts per second).

Based on the obtained intensity of X-rays (cps) of the adhesive surface of the pressure-sensitive adhesive layer and the obtained intensity of X-rays (cps) of the surface of the release layer of the release liner, the amount of silicone in the pressure-sensitive adhesive layer (the transfer amount of silicone) (g/m²) and the amount of silicone on the release layer (the remaining amount of silicone) (g/m²) were calculated in terms of polydimethylsiloxane. The conversion expression is 100 kcps=0.60 g/m². The results are indicated in Tables 1 and 2.

Based on the obtained intensity of X-rays (cps) of the pressure-sensitive adhesive layer and the obtained intensity of X-rays (cps) of the surface of the release layer of the release liner, the rate of the amount of silicone transferred from the release layer to the pressure-sensitive adhesive layer (the transfer rate) was calculated. The results are indicated in Tables 1 and 2.

Product name “ZSX100E” supplied by RIGAKU Corporation was used as the fluorescence X-ray analysis device in measuring the transfer amount of silicone and Rh was used as an X-ray source. RX-4 was used as a spectral crystal and output power was set 70 mA at 50 kV and the intensity of X-rays was measured.

[Evaluation 3: 180° Peel Adhesion Strength]

One release liner was separated from the pressure-sensitive adhesive sheet and a PET film having a thickness of 25 μm was attached thereto for backing. The backed pressure-sensitive adhesive sheet was cut into a rectangular shape having a size of 20 mm by 150 mm and provided as a test sample. Another release liner was separated from the test sample, and an uncovered adhesive surface was attached to a stainless steel (SUS: B304) plate, which is an adherend, by moving back and forth a 2 kg-roller once. After having been kept at a temperature of 23° C. and a humidity 50% RH for thirty minutes, the test sample was measured for its 180° peel adhesion strength (N/20 mm) with respect to SUS with using a tensile tester (product name “TENSILON” supplied by Shimadzu Corporation) according to JIS Z 0237 at a peel angle of 180° and a tension rate of 300 mm/min. The results are indicated in Tables 1 and 2.

TABLE 1

| | | | | | EXAMPLES | | | | | | | |
|---|---|---|---|---|---|---|---|---|---|---|---|---|
| | | | | | 1 | 2 | 3 | 4 | 5 | 6 | 7 | 8 |
| PRES | PRES | ACRYLIC | NON-ACIDIC | KIND | NVP | NVP | NVP | NVP | NVP | NVP | NVP | NVP |
| SURE- | SURE- | POLYMER | POLAR | PARTS | 10 | 10 | 10 | 10 | 10 | 10 | 10 | 10 |
| SENSI- | SENSI- | | MONOMER | BY | | | | | | | | |
| TIVE | TIVE | | | MASS | | | | | | | | |
| ADHE- | ADHE- | | ALKYL | KIND | MA | EA | BA | 2EHA | iOA | iNA | LA | iSTA |
| SIVE | SIVE | | ACRYLATE | PARTS | 90 | 90 | 90 | 90 | 90 | 90 | 90 | 90 |
| SHEET | LAYER | | | BY | | | | | | | | |
| | | | | MASS | | | | | | | | |
| | | THICKNESS (μm) | | | 50 | 50 | 50 | 50 | 50 | 50 | 50 | 50 |
| | RELEASE | RELEASE | APPLICATION | | 0.055 | 0.055 | 0.055 | 0.055 | 0.055 | 0.055 | 0.055 | 0.055 |
| | LINER | LAYER | AMOUNT OF | | | | | | | | | |
| | | | SILICONE RELEASE | | | | | | | | | |
| | | | AGENT (g/m²) | | | | | | | | | |
| | | | THICKNESS (μm) | | 0.1 | 0.1 | 0.1 | 0.1 | 0.1 | 0.1 | 0.1 | 0.1 |
| | | SUPPORT BASE | | | PET | PET | PET | PET | PET | PET | PET | PET |
| EVAL- | AMOUNT OF SILOXANE GAS (ng/cm²) | | | | 15 | 12 | 0 | 0 | 0 | 0 | 0 | 0 |
| UATION | AMOUNT OF OUTGAS (ng/cm²) | | | | 500 | 450 | 400 | 300 | 275 | 250 | 200 | 175 |
| 1 | | | | | | | | | | | | |
| EVAL- | AMOUNT OF Si TRANSFERRED | | | | 0.002 | 0.001 | 0.001 | 0.001 | 0.001 | 0.001 | 0.001 | 0.001 |
| UATION | TO PRESSURE-SENSITIVE | | | | | | | | | | | |
| 2 | ADHESIVE LAYER (g/m²) | | | | | | | | | | | |
| | AMOUNT OF Si REMAINING | | | | 0.053 | 0.054 | 0.054 | 0.054 | 0.054 | 0.054 | 0.054 | 0.054 |
| | ON RELEASE LINER (g/m²) | | | | | | | | | | | |
| | TRANSFER RATE (%) | | | | 3.6 | 1.8 | 1.8 | 1.8 | 1.8 | 1.8 | 1.8 | 1.8 |
| EVAL- | 180° PEELADHESION STRENGTH | | | | 10 | 11 | 12 | 14 | 14 | 14 | 15 | 15 |
| UATION | (N/20 mm) | | | | | | | | | | | |
| 3 | | | | | | | | | | | | |
| | | | | | | | | | | COMPARATIVE | | |
| | | | | | EXAMPLES | | | | | EXAMPLES | | |
| | | | | | 9 | 10 | 11 | 12 | 13 | 1 | 2 | 3 |
| PRES | PRES | ACRYLIC | NON-ACIDIC | KIND | NVP | NVP | NVP | NVP | NVP | AA | AA | AA |
| SURE- | SURE- | POLYMER | POLAR | PARTS | 10 | 10 | 5 | 15 | 20 | 10 | 10 | 10 |
| SENSI- | SENSI- | | MONOMER | BY | | | | | | | | |
| TIVE | TIVE | | | MASS | | | | | | | | |
| ADHE- | ADHE- | | ALKYL | KIND | STA/ | iSTA/ | 2EHA | 2EHA | 2EHA | 2EHA | iOA | iNA |
| SIVE | SIVE | | ACRYLATE | | 2EHA | 2EHA | | | | | | |
| SHEET | LAYER | | | PARTS | (45/45) | (45/45) | 95 | 85 | 80 | 90 | 90 | 90 |
| | | | | BY | | | | | | | | |
| | | | | MASS | | | | | | | | |

| | THICKNESS (μm) | | 50 | 50 | 50 | 50 | 50 | 50 | 50 | 50 |
|---|---|---|---|---|---|---|---|---|---|---|
| RELEASE | RELEASE | APPLICATION | 0.055 | 0.055 | 0.055 | 0.055 | 0.055 | 0.055 | 0.055 | 0.055 |
| LINER | LAYER | AMOUNT OF | | | | | | | | |
| | | SILICONE RELEASE | | | | | | | | |
| | | AGENT (g/m²) | | | | | | | | |
| | | THICKNESS (μm) | 0.1 | 0.1 | 0.1 | 0.1 | 0.1 | 0.1 | 0.1 | 0.1 |

| | | | | | | | | |
|---|---|---|---|---|---|---|---|---|
| SUPPORT BASE | PET | PET | PET | PET | PET | PET | PET | PET |

| | | | | | | | | | |
|---|---|---|---|---|---|---|---|---|---|
| EVAL- | AMOUNT OF SILOXANE GAS (ng/cm²) | 0 | 0 | 0 | 0 | 1.6 | 100 | 100 | 100 |
| UATION | AMOUNT OF OUTGAS (ng/cm²) | 170 | 200 | 300 | 300 | 300 | 600 | 400 | 350 |
| 1 | | | | | | | | | |
| EVAL- | AMOUNT OF Si TRANSFERRED | 0.001 | 0.001 | 0.001 | 0.001 | 0.001 | 0.020 | 0.020 | 0.020 |
| UATION | TO PRESSURE-SENSITIVE | | | | | | | | |
| 2 | ADHESIVE LAYER (g/m²) | | | | | | | | |
| | AMOUNT OF Si REMAINING | 0.054 | 0.054 | 0.054 | 0.054 | 0.051 | 0.035 | 0.035 | 0.035 |
| | ON RELEASE LINER (g/m²) | | | | | | | | |
| | TRANSFER RATE (%) | 1.8 | 1.8 | 1.8 | 1.8 | 5.6 | 36.4 | 36.4 | 36.4 |
| EVAL- | 180° PEELADHESION STRENGTH | 15 | 16 | 7 | 17 | 20 | 16 | 16 | 17 |
| UATION | (N/20 mm) | | | | | | | | |
| 3 | | | | | | | | | |

TABLE 2

| | | | | | COM- | | | COM- | COM- |
|---|---|---|---|---|---|---|---|---|---|
| | | | | | PARATIVE | EXAM- | EXAM- | PARATIVE | PARATIVE |
| | | | | | EXAMPLE | PLE | PLE | EXAMPLE | EXAMPLE |
| | | | | | 4 | 4 | 14 | 5 | 6 |
| PRESSURE- | PRESSURE- | ACRYLIC | NON-ACIDIC | KIND | NVP | NVP | NVP | NVP | NVP |
| SENSITIVE | SENSITIVE | POLYMER | POLAR | PARTS | 10 | 10 | 10 | 10 | 10 |
| ADHESIVE | ADHESIVE | | MONOMER | BY MASS | | | | | |
| SHEET | LAYER | | ALKYL | KIND | 2EHA | 2EHA | 2EHA | 2EHA | 2EHA |
| | | | ACRYLATE | PARTS | 90 | 90 | 90 | 90 | 90 |
| | | | | BY MASS | | | | | |

| | THICKNESS (μm) | | 50 | 50 | 50 | 50 | 50 |
|---|---|---|---|---|---|---|---|
| RELEASE | RELEASE | APPLICATION | 0 | 0.055 | 0.143 | 0.215 | 0.505 |
| LINER | LAYER | AMOUNT OF | | | | | |
| | | SILICONE RELEASE | | | | | |
| | | AGENT (g/m²) | | | | | |
| | | THICKNESS (μm) | 0 | 0.06 | 0.14 | 0.22 | 0.51 |

| | | | | | |
|---|---|---|---|---|---|
| SUPPORT BASE | PET | PET | PET | PET | PET |

| | | | | | | |
|---|---|---|---|---|---|---|
| EVAL- | AMOUNT OF SILOXANE GAS (ng/cm²) | — | 0 | 1.5 | 78 | 525 |
| UATION 1 | AMOUNT OF OUTGAS (ng/cm²) | — | 300 | 300 | 300 | 300 |
| EVAL- | AMOUNT OF Si TRANSFERRED TO | — | 0.001 | 0.003 | 0.015 | 0.105 |
| UATION 2 | PRESSURE-SENSITIVE ADHESIVE LAYER (g/m²) | | | | | |
| | AMOUNT OF Si REMAINING | — | 0.054 | 0.140 | 0.200 | 0.400 |
| | ON RELEASE LINER (g/m²) | | | | | |
| | TRANSFER RATE (%) | — | 1.8 | 2.1 | 7.0 | 20.8 |
| EVAL- | 180° PEEL ADHESION STRENGTH (N/20 mm) | — | 14 | 14 | 13 | 10 |
| UATION 3 | | | | | | |

As indicated in Tables 1 and 2, it was confirmed that the amount of siloxane gas generated in each of the pressure-sensitive adhesive sheets of Examples 1 to 14 is 20.0 ng/cm² or less. This amount of siloxane gas is substantially same as that of conventional products without including silicone. The amount of siloxane gas generated in each of Examples 3 to 14 is 2.0 n/g cm² or less and no siloxane gas was detected in Examples 3 to 12.

The amount of siloxane gas generated in each of the pressure-sensitive adhesive sheets of Comparative Examples 1 to 3 is 100 ng/cm² or more. Such pressure-sensitive adhesive sheets cannot be used in a situation where generation of siloxane gas is not desired such as a hard disc drive.

In the pressure-sensitive adhesive sheet of Comparative Example 4, the release liner (the release liner without including the release layer and including only the support base) cannot be separated from the pressure-sensitive adhesive layer. Therefore, Evaluations 1 to 3 cannot be performed for the pressure-sensitive adhesive sheet of Comparative Example 4. A mark “-” in Table 2 represents that Evaluation cannot be performed.

The amount of siloxane gas generated in the pressure-sensitive adhesive sheet of Comparative Example 5 is 78 ng/cm² and the amount of siloxane gas generated in the pressure-sensitive adhesive sheet of Comparative Example 6 is 525 ng/cm². The pressure-sensitive adhesive sheets of Comparative Examples 5 and 6 have a configuration same as that of Example 4 except for having a thickness of the release layer of the release liner being greater than that of Example 4. Namely, in the pressure-sensitive adhesive sheets of Comparative Examples 5 and 6, the amount of the silicone release agent applied on the support base for forming the release layer of the release liner is greater than that of Example 4. As the thickness of the release layer of the release liner is increased (namely, as the amount of the silicone release agent is increased), it is assumed that mechanical connection is increased due to the anchor effect as interaction between the pressure-sensitive adhesive layer and the release layer. Therefore, in the pressure-sensitive adhesive sheets of Comparative Examples 5 and 6, it is assumed that a large amount of silicone is transferred from the release liner to the pressure-sensitive adhesive layer and the amount of generated siloxane gas is increased.

In the pressure-sensitive adhesive sheet of Example 14, the pressure-sensitive adhesive layer has a configuration same as that of Example 4 and the release layer of the release liner has a thickness greater than that of Example 4. The thickness of the release layer of the release liner of Example 14 is smaller than that of Comparative Examples 5 and 6. The amount of siloxane gas generated in the pressure-sensitive adhesive sheet of Example 14 is 1.5 ng/cm².

In Examples 3 to 14, the alkyl acrylate includes a linear or branched chain alkyl group with a carbon number of 4 to 18. In Examples 1 and 2, the alkyl acrylate includes a linear chain alkyl group with a carbon number of 1 or 2. According to the results of Evaluation 2, the amount of silicone transferred from the release liner to the pressure-sensitive adhesive layer is quite small in Examples 3 to 14 and Examples 1 and 2. However, according to the results of Evaluation 1, the amount of siloxane gas generated from the pressure-sensitive adhesive layer after heating is smaller in Examples 3 to 14 than in Examples 1 and 2. It is assumed that a small amount of silicone transferred to the pressure-sensitive adhesive layer (siloxane gas) is kept in the pressure-sensitive adhesive layer.

1. A pressure-sensitive adhesive sheet comprising:
a pressure-sensitive adhesive layer including an acrylic polymer; and
a release liner including a release layer made of a silicone release agent, the release layer being applied on the pressure-sensitive adhesive layer, wherein
the acrylic polymer includes at least one alkyl(meth)acrylate whose alkyl group being a linear or branched chain alkyl group with a carbon number of 1 to 18 as a monomer unit, and
an amount of siloxane gas generated in a unit area of the pressure-sensitive adhesive layer where the release liner is removed is less than 20.0 ng/cm² after heating at 120° C. for ten minutes.

2. The pressure-sensitive adhesive sheet according to claim 1, wherein an amount of outgas (except for the siloxane gas) generated in a unit area of the pressure-sensitive adhesive layer where the release liner is removed is less than 500 ng/cm² after heating at 120° C. for ten minutes.

3. The pressure-sensitive adhesive sheet according to claim 1, wherein the release layer is made of a silicone release agent with an amount of 0.15 g/m² or less in a unit area in terms of polydimethylsiloxane.

4. The pressure-sensitive adhesive sheet according to claim 1, wherein when the release liner is separated from the pressure-sensitive adhesive layer, an amount of silicone transferred from the release layer to the pressure-sensitive adhesive layer is 0.005 g/m² or less in a unit area in terms of polydimethylsiloxane.

5. The pressure-sensitive adhesive sheet according to claim 1, wherein when the release liner is separated from the pressure-sensitive adhesive layer, an rate of silicone transferred from the release layer to the pressure-sensitive adhesive layer is less than 30% by mass in terms of polydimethylsiloxane.

6. The pressure-sensitive adhesive sheet according to claim 1, wherein
the acrylic polymer includes at least one monomer containing a polar group as a monomer unit, and
the at least one monomer containing the polar group includes only a non-acidic polar monomer including no acidic group as the polar group.

7. The pressure-sensitive adhesive sheet according to claim 6, wherein the non-acidic polar monomer is included as a monomer unit (% by mass) is 3% by mass or more based on a total amount of the monomer unit (100% by mass).

8. The pressure-sensitive adhesive sheet according to claim 1, wherein the alkyl(meth)acrylate includes a linear or branched chain alkyl group with a carbon number of 4 to 18.

9. The pressure-sensitive adhesive sheet according to claim 1, wherein the pressure-sensitive adhesive layer has 180° peel adhesion strength of 10 N/20 mm or more.

10. The pressure-sensitive adhesive sheet according to claim 1 used in a precision electronic device.

11. A method of using the pressure-sensitive adhesive sheet according to claim 1 in a precision electronic device, the method comprising:
separating the release liner from the pressure-sensitive adhesive layer; and
attaching the pressure-sensitive adhesive layer on a part of the precision electronic device.

12. A precision electronic device comprising the pressure-sensitive adhesive sheet according to claim 1.

13. The pressure-sensitive adhesive sheet according to claim 2, wherein the release layer is made of a silicone release agent with an amount of 0.15 g/m² or less in a unit area in terms of polydimethylsiloxane.

14. The pressure-sensitive adhesive sheet according to claim 2, wherein when the release liner is separated from the pressure-sensitive adhesive layer, an amount of silicone transferred from the release layer to the pressure-sensitive adhesive layer is 0.005 g/m² or less in a unit area in terms of polydimethylsiloxane.

15. The pressure-sensitive adhesive sheet according to claim 3, wherein when the release liner is separated from the pressure-sensitive adhesive layer, an amount of silicone transferred from the release layer to the pressure-sensitive adhesive layer is 0.005 g/m² or less in a unit area in terms of polydimethylsiloxane.

16. The pressure-sensitive adhesive sheet according to claim 2, wherein when the release liner is separated from the pressure-sensitive adhesive layer, an rate of silicone transferred from the release layer to the pressure-sensitive adhesive layer is less than 30% by mass in terms of polydimethylsiloxane.

17. The pressure-sensitive adhesive sheet according to claim 3, wherein when the release liner is separated from the pressure-sensitive adhesive layer, an rate of silicone transferred from the release layer to the pressure-sensitive adhesive layer is less than 30% by mass in terms of polydimethylsiloxane.

18. The pressure-sensitive adhesive sheet according to claim 4, wherein when the release liner is separated from the pressure-sensitive adhesive layer, an rate of silicone transferred from the release layer to the pressure-sensitive adhesive layer is less than 30% by mass in terms of polydimethylsiloxane.

19. The pressure-sensitive adhesive sheet according to claim 2, wherein
the acrylic polymer includes at least one monomer containing a polar group as a monomer unit, and
the at least one monomer containing the polar group includes only a non-acidic polar monomer including no acidic group as the polar group.

20. The pressure-sensitive adhesive sheet according to claim 3, wherein
the acrylic polymer includes at least one monomer containing a polar group as a monomer unit, and
the at least one monomer containing the polar group includes only a non-acidic polar monomer including no acidic group as the polar group.
